(19) United States
(12) Patent Application Publication
(10) Pub. No.: US 2025/0309371 A1
(43) Pub. Date: Oct. 2, 2025

(54) ELECTRODE LAMINATE

(71) Applicant: HONDA MOTOR CO., LTD., Tokyo (JP)

(72) Inventors: Akihiro Taguchi, Wako-shi (JP); Terumi Furuta, Wako-shi (JP)

(21) Appl. No.: 19/091,963

(22) Filed: Mar. 27, 2025

(30) Foreign Application Priority Data
Mar. 29, 2024 (JP) 2024-058289

(51) Int. Cl. H01M 10/42; H01M 4/02

(52) U.S. Cl. CPC H01M 10/4235; H01M 2004/021; H01M 2004/028

(57) ABSTRACT

A problem to be solved by the present invention is to suppress concentration of current at a boundary between a positive electrode active material layer and an insulating member in a positive electrode of a battery, and suppress localized deposition of lithium on a negative electrode side containing metallic lithium or a lithium alloy. Provided is an electrode laminate in which a solid electrolyte layer has a low ion conductivity region in a region extending to a distance in one direction in a direction perpendicular to a thickness direction of the solid electrolyte layer and in a region extending to a distance in the other direction from a boundary line between a positive electrode active material layer and an insulating member, the positive electrode active material layer has an inclined portion that is inclined so that a width thereof reduces in a direction away from a positive electrode current collector.

### CROSS-REFERENCE TO RELATED APPLICATION

Priority is claimed on Japanese Patent Application No. 2024-058289, filed on Mar. 29, 2024, the contents of which are incorporated herein by reference.

### BACKGROUND OF THE INVENTION

### Field of the Invention

The present invention relates to a manufacturing method of an electrode laminate.

### Description of Related Art

Batteries such as all-solid-state batteries are manufactured such that, for example, a sheet with a positive electrode active material layer formed by applying an electrode composite material onto a positive electrode current collector, an insulating member formed on an outer circumference of the positive electrode active material layer, and a solid electrolyte disposed on an upper surface of the positive electrode active material layer is cut into an arbitrary shape, which is then press-formed after alternately laminating a positive electrode and a negative electrode.

In the positive electrode of the battery obtained in this way, the positive electrode active material layer has an inclined portion that is inclined to widen toward the positive electrode current collector (see, for example, Patent Document 1).

### PATENT DOCUMENTS

[Patent Document 1] Japanese Unexamined Patent Application, First Publication No. 2020-173954

### SUMMARY OF THE INVENTION

When the positive electrode active material layer has an inclined portion that is inclined to widen toward the positive electrode current collector, a problem arises in that a current concentrates at a boundary between the positive electrode active material layer and the insulating member, causing localized deposition of lithium on a negative electrode side containing metallic lithium or a lithium alloy.

In order to solve the above-described problem, the present application is directed to suppress concentration of current at a boundary between a positive electrode active material layer and an insulating member in a positive electrode of a battery, and suppress localized deposition of lithium on a negative electrode side containing metallic lithium or a lithium alloy. Then, the present invention eventually contributes to improving energy efficiency.

In order to achieve the above-described objective, the present invention provides the following means.

[1] An electrode laminate, which is an electrode laminate utilizing a deposition-dissolution reaction of metallic lithium as a reaction of a negative electrode, includes a positive electrode current collector, a positive electrode active material layer, a solid electrolyte layer, and a negative electrode current collector, in which an insulating member is disposed on an outer circumference of the positive electrode active material layer, the solid electrolyte layer has a low ion conductivity region, in which an ionic conductivity of a solid electrolyte is lower than an ionic conductivity of a solid electrolyte at a central portion of the solid electrolyte layer, in a region extending from a boundary line between the positive electrode active material layer and the insulating member to a distance A in one direction in a direction perpendicular to a thickness direction of the solid electrolyte layer and a region extending from the boundary line between the positive electrode active material layer and the insulating member to a distance B in the other direction in a direction perpendicular to the thickness direction of the solid electrolyte layer, the positive electrode active material layer has an inclined portion which is inclined so that a width thereof reduces in a direction away from the positive electrode current collector.

The electrode laminate of the present invention can suppress concentration of current at a boundary between the positive electrode active material layer and the insulating member, and can suppress localized deposition of lithium on a negative electrode side for an all-solid-state battery containing metallic lithium or a lithium alloy.

[2] In the electrode laminate according to [1] described above, the distance A and the distance B satisfy the following relational expression (1).

Distance A≥Distance B (1)

The electrode laminate of the present invention can suppress concentration of current at a boundary between the positive electrode active material layer and the insulating member, and can suppress localized deposition of lithium on a negative electrode side for an all-solid-state battery containing metallic lithium or a lithium alloy.

[3] In the electrode laminate according to [1] described above, a first contact portion, at which the inclined portion and the solid electrolyte layer are in contact, may have a high proportion of the low ion conductivity region in a distance from a second contact portion, at which the inclined portion and the positive electrode current collector are in contact, to a point on the solid electrolyte layer when a straight line is drawn in a lamination direction.

The electrode laminate of the present invention can suppress concentration of current at a boundary between the positive electrode active material layer and the insulating member, and can suppress localized deposition of lithium on a negative electrode side for an all-solid-state battery containing metallic lithium or a lithium alloy.

[4] In the electrode laminate according to [1] described above, the distance A may be 500 μm or less, and the distance B may be 500 μm or less.

The electrode laminate of the present invention can suppress concentration of current at a boundary between the positive electrode active material layer and the insulating member, and can suppress localized deposition of lithium on a negative electrode side for an all-solid-state battery containing metallic lithium or a lithium alloy.

According to the present invention, it is possible to suppress concentration of current at a boundary between a positive electrode active material layer and an insulating member in a positive electrode of a battery, and suppress localized deposition of lithium on a negative electrode side containing metallic lithium or a lithium alloy.

### BRIEF DESCRIPTION OF THE DRAWINGS

FIG. 1 is a cross-sectional view illustrating an example of an electrode laminate according to an embodiment of the present invention.

FIG. 2 is a diagram showing results of simulating a current density of the electrode laminate according to the embodiment of the present invention.

FIG. 3 is a cross-sectional view illustrating an example of the electrode laminate in an experimental example.

FIG. 4 is a diagram showing results of simulating a current density of a solid electrolyte layer in experimental example 1.

FIG. 5 is a diagram showing results of simulating a current density of the solid electrolyte layer in experimental example 2.

FIG. 6 is a diagram showing results of simulating a current density of the solid electrolyte layer in experimental example 3.

FIG. 7 is a diagram showing results of simulating a current density of the solid electrolyte layer in experimental example 4.

FIG. 8 is a diagram showing results of simulating a current density of the solid electrolyte layer in experimental example 5.

FIG. 9 is a diagram showing results of simulating a current density of the solid electrolyte layer in experimental example 6.

FIG. 10 is a diagram showing results of simulating a current density of the solid electrolyte layer in experimental example 7.

FIG. 11 is a diagram showing results of simulating a current density of the solid electrolyte layer in experimental example 8.

FIG. 12 is a diagram showing results of simulating a current density of the solid electrolyte layer in experimental example 9.

FIG. 13 is a diagram showing results of simulating a current density of the solid electrolyte layer in experimental example 10.

FIG. 14 is a diagram showing results of simulating a current density of the solid electrolyte layer in experimental example 11.

FIG. 15 is a diagram showing results of simulating a current density of the solid electrolyte layer in experimental example 12.

FIG. 16 is a diagram showing results of simulating a current density of the solid electrolyte layer in experimental example 13.

FIG. 17 is a diagram showing results of simulating a current density of the solid electrolyte layer in experimental example 14.

### DETAILED DESCRIPTION OF THE INVENTION

Hereinafter, an electrode laminate according to one embodiment of the present invention will be described with reference to the drawings.

### [Electrode Laminate]

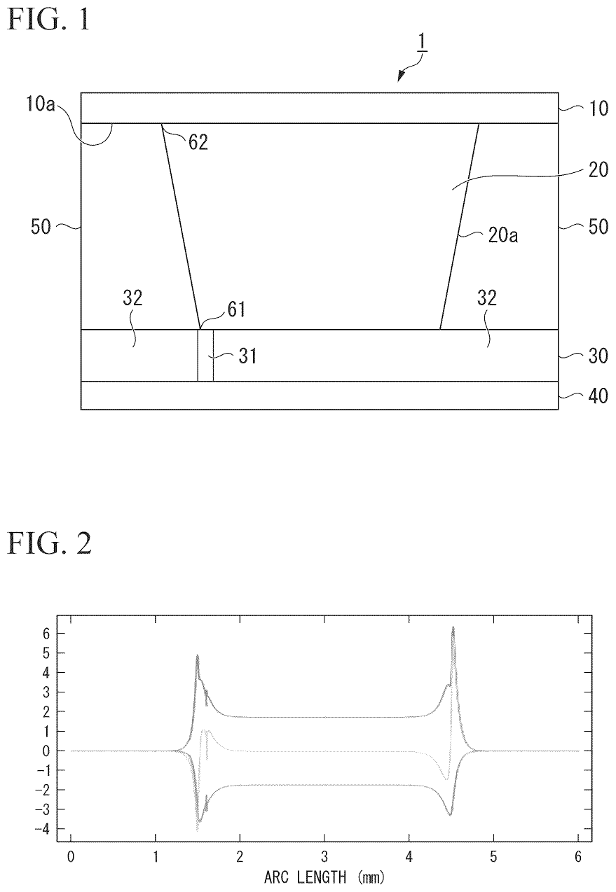

FIG. 1 is a cross-sectional view illustrating an example of an electrode laminate according to an embodiment of the present invention. Further, in the drawings used in the following description, characteristic portions may be enlarged for convenience of illustration to facilitate understanding of the characteristics, and dimensional proportions or the like of the respective constituent elements are not limited to those illustrated in the drawings.

As illustrated in FIG. 1, the electrode laminate 1 includes a positive electrode current collector 10, a positive electrode active material layer 20, a solid electrolyte layer 30, and a negative electrode current collector 40. The positive electrode current collector 10, the positive electrode active material layer 20, the solid electrolyte layer 30, and the negative electrode current collector 40 are laminated in the electrode laminate 1.

The positive electrode active material layer 20 is formed on one main surface 10a of the positive electrode current collector 10.

The positive electrode active material layer 20 has an inclined portion 20a that is inclined so that a width thereof reduces in a direction away from the one main surface 10a of the positive electrode current collector 10 (in a thickness direction of the positive electrode active material layer 20). An angle of the inclined portion 20a with respect to the one main surface 10a of the positive electrode current collector 10 is not particularly limited, and is adjusted according to a capacity of the positive electrode active material layer 20, a thickness of the solid electrolyte layer 30, and the like. In the present embodiment, a current density of the electrode laminate 1 is derived by a simulation, and an angle of the inclined portion 20a with respect to the one main surface 10a of the positive electrode current collector 10 is adjusted on the basis of results of the simulation.

An insulating member 50 is disposed on an outer circumference of the positive electrode active material layer 20.

The insulating member 50 has an inclined portion that is inclined to widen toward the one main surface 10a of the positive electrode current collector 10 (in a thickness direction of the positive electrode current collector 10). An angle of the inclined portion with respect to the one main surface 10a of the positive electrode current collector 10 is not particularly limited and is adjusted according to a capacity of the positive electrode active material layer 20, a thickness of the solid electrolyte layer 30, and the like.

The solid electrolyte layer 30 has a low ion conductivity region 31, in which an ionic conductivity of a solid electrolyte is lower than an ionic conductivity of a solid electrolyte at a central portion of the solid electrolyte layer 30, in a region extending from a boundary line between the positive electrode active material layer 20 and the insulating member 50 to a distance A in one direction in a direction perpendicular to a thickness direction of the solid electrolyte layer 30 (a direction to the right of the boundary line between the positive electrode active material layer 20 and the insulating member 50 in FIG. 1) and a region extending from the boundary line between the positive electrode active material layer 20 and the insulating member 50 to a distance B in the other direction in a direction perpendicular to the thickness direction of the solid electrolyte layer 30 (a direction to the left of the boundary line between the positive electrode active material layer 20 and the insulating member 50 in FIG. 1). Also, the solid electrolyte layer 30 has a high ion conductivity region 32, in which an ionic conductivity of the solid electrolyte is higher than the ionic conductivity of the solid electrolyte at the central portion of the solid electrolyte layer 30, on an outer circumferential side of the low ion conductivity region 31.

The distance A and the distance B satisfy the following relational expression (1).

Distance A≥Distance B (1)

The distance A is preferably 500 μm or less. The distance B is preferably 500 μm or less.

A first contact portion 61, at which the inclined portion 20a and the solid electrolyte layer 30 are in contact, has a higher proportion of the low ion conductivity region 31 than the high ion conductivity region 32 in a distance from a second contact portion 62, at which the inclined portion 20a and the positive electrode current collector 10 are in contact, to a point on the solid electrolyte layer 30 when a straight line is drawn in a lamination direction.

### (Positive Electrode)

The positive electrode current collector 10 is preferably formed of at least one material with a high conductivity.

As the material with a high conductivity, examples may include metals or alloys containing at least one metallic element from, for example, silver (Ag), palladium (Pd), gold (Au), platinum (Pt), aluminum (Al), copper (Cu), chromium (Cr), and nickel (Ni), or non-metallic carbon (C). When manufacturing costs are considered in addition to high conductivity, aluminum, nickel, or stainless steel is preferable. Further, aluminum does not easily react with the positive electrode active material, the negative electrode active material, and the solid electrolyte. Therefore, when aluminum is used for the positive electrode current collector 10, internal resistance of the electrode laminate 1 can be reduced.

As a form of the positive electrode current collector 10, examples include a foil shape, a plate shape, a mesh shape, a nonwoven fabric form, a foam form, and the like. Also, in order to enhance adhesion to the positive electrode active material layer 20, a surface of the positive electrode current collector 10 may have carbon or the like disposed thereon, or the surface may be roughened.

The positive electrode active material layer 20 contains a positive electrode active material that exchanges lithium ions and electrons. The positive electrode active material is not particularly limited as long as it is a material capable of reversibly releasing and absorbing lithium ions and transporting electrons, and a known positive electrode active material that can be applied to a positive electrode of an all-solid-state lithium ion battery can be used. Examples may include composite oxides such as lithium cobalt oxide (LiCoO₂), lithium nickel oxide (LiNiO₂), lithium manganese oxide (LiMn₂O₄), solid solution oxide (Li₂MnO₃-LiMO₂ (M=Co, Ni, or the like)), lithium-manganese-nickel-cobalt oxide (LiNiₓMn_{y}Co₂O₂, x+y+z=1), and olivine-type lithium phosphate oxide (LiFePO₄); conductive polymers such as polyaniline and polypyrrole; sulfides such as Li₂S, CuS, Li—Cu—S compounds, TiS₂, FeS, MoS₂, and Li—Mo—S compounds; a mixture of sulfur and carbon; and the like. The positive electrode active material may be composed of one type of the above-described materials alone, or may be composed of two or more types of the above-described materials.

The positive electrode active material layer 20 may contain a conductive assistant from the viewpoint of enhancing conductivity. As the conductive assistant, any conductive assistant that can be generally used for all-solid-state lithium ion batteries can be used. For example, carbon materials including carbon black such as acetylene black and ketjen black; carbon fibers; vapor-grown carbon fibers; graphite powder; carbon nanotubes, and the like can be mentioned. The conductive assistant may be composed of one type of the above-described materials alone, or may be composed of two or more types of the above-described materials.

Also, the positive electrode active material layer 20 may also contain a binder that serves to bind the positive electrode active materials and between the positive electrode active material and the positive electrode current collector 10.

In the present embodiment, the positive electrode active material layer 20 is formed on one main surface 10a of the positive electrode current collector 10, but the present embodiment is not limited thereto, and the positive electrode active material layer 20 may be formed on both main surfaces of the positive electrode current collector 10. Also, when the positive electrode active material layer 20 has a three-dimensional porous structure such as a mesh shape, a nonwoven fabric form, or a foam form, the positive electrode active material layer 20 may be provided integrally with the positive electrode current collector 10.

### (Solid Electrolyte Layer)

The solid electrolyte layer 30 is disposed between the positive electrode active material layer 20 and the negative electrode current collector 40.

The solid electrolyte described above is not particularly limited as long as it has lithium ion conductivity and insulating properties, and materials generally used in all-solid-state lithium ion batteries can be used. For example, examples include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts and ionic liquids having lithium ion conductivity; and the like. Among these, sulfide solid electrolyte materials are preferred from the perspective of high conductivity of lithium ions, and satisfactory structure formability and interfacial adhesion by pressing.

A form of the solid electrolyte material is not particularly limited, and may be, for example, a particulate form.

The solid electrolyte layer 30 may contain an adhesive to impart mechanical strength and flexibility.

The solid electrolyte layer 30 may have a sheet shape including a support and a solid electrolyte held by the support. A form of the above-described support is not particularly limited, and examples thereof may include woven fabrics, nonwoven fabrics, mesh cloths, porous membranes, expanded sheets, punched sheets, and the like. Among these forms, nonwoven fabrics are preferable from the perspective of ease of handling, which allows for a higher filling amount of the solid electrolyte.

The support described above is preferably formed of an insulating material. Thereby, insulating properties of the solid electrolyte layer 30 can be improved. As the insulating materials, examples may include resin materials such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resin; natural fibers such as hemp, wood pulp, and cotton linters, glass, and the like.

### (Negative Electrode)

The negative electrode utilizes a deposition-dissolution reaction of metallic lithium and has a second active material layer containing at least a negative electrode active material.

A second current collector layer contains at least copper (Cu). Similarly to the first current collector layer, the second current collector layer may contain a highly conductive material other than copper. As the highly conductive material other than copper, examples may include metals or alloys containing at least one metallic element from, for example, silver (Ag), palladium (Pd), gold (Au), platinum (Pt), chromium (Cr), and nickel (Ni), or non-metallic carbon (C). When manufacturing costs are considered in addition to high conductivity, nickel or stainless steel is preferable as the material other than copper. Further, stainless steel does not easily react with the positive electrode active material, the negative electrode active material, and the electrolyte. Therefore, when stainless steel is used for the second current collector layer, manufacturing costs of batteries can be reduced.

As a form of the second current collector layer, examples include a foil shape, a plate shape, a mesh shape, a nonwoven fabric form, a foam form, and the like. Also, in order to enhance adhesion to the second current collector layer, a surface of the second current collector layer may have carbon or the like disposed thereon, or the surface may be roughened.

The second active material layer contains a negative electrode active material that exchanges lithium ions and electrons. The negative electrode active material is not particularly limited as long as it is a material capable of reversibly releasing and absorbing lithium ions and transporting electrons, and a known negative electrode active material that can be applied to a negative electrode of a lithium ion battery can be used. Examples may include carbonaceous materials such as natural graphite, artificial graphite, resin carbon, carbon fiber, activated carbon, hard carbon, and soft carbon; alloy-based materials mainly composed of tin, tin alloys, silicon, silicon alloys, gallium, gallium alloys, indium, indium alloys, aluminum, aluminum alloys, and the like; conductive polymers such as polyacene, polyacetylene, and polypyrrole; metallic lithium; and lithium alloys such as lithium titanium composite oxides (for example, Li₄Ti₂O₁₂); and the like. The negative electrode active material may be composed of one type of the above-described materials alone, or may be composed of two or more types of the above-described materials.

The second active material layer contains an electrolyte that exchanges lithium ions with the negative electrode active material. The electrolyte is not particularly limited as long as it has lithium ion conductivity, and materials generally used in lithium ion batteries can be used. As the electrolyte, examples include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes including lithium-containing salts or lithium ion-conductive ionic liquids, and the like. The electrolyte may be composed of one type of the above-described materials alone, or may be composed of two or more types of the above-described materials.

The electrolyte contained in the second active material layer may be the same as or different from the electrolyte contained in the first active material layer or the solid electrolyte layer.

The second active material layer may contain a conductive assistant, a binder, and the like. These materials are not particularly limited, and for example, materials similar to those used for the first active material layer described above can be used.

The second active material layer may be formed on both main surfaces of the second current collector layer, or may be formed on only one main surface of the second current collector layer. Also, if the second current collector layer has a three-dimensional porous structure such as a mesh shape, a nonwoven fabric form, or a foam form, the second current collector layer may be provided integrally with the second active material layer.

### (Insulating Member)

An insulating material forming the insulating member 50 is not particularly limited, and examples thereof may include insulating oxides such as alumina, resins such as polyvinylidene fluoride (PVDF), rubbers such as styrene-butadiene rubber (SBR), and the like.

According to the electrode laminate 1 of the present embodiment, the positive electrode active material layer 20 is formed on the one main surface 10a of the positive electrode current collector 10, the positive electrode active material layer 20 has the inclined portion 20a that is inclined so that a width thereof reduces in a direction away from the one main surface 10a of the positive electrode current collector 10, the solid electrolyte layer 30 has the low ion conductivity region 31, in which an ionic conductivity of a solid electrolyte is lower than an ionic conductivity of a solid electrolyte at a central portion of the solid electrolyte layer 30, in a region extending from the boundary line between the positive electrode active material layer 20 and the insulating member 50 to the distance A in one direction in a direction perpendicular to a thickness direction of the solid electrolyte layer 30 and a region extending from the boundary line between the positive electrode active material layer 20 and the insulating member 50 to the distance B in the other direction in a direction perpendicular to the thickness direction of the solid electrolyte layer 30, and since the positive electrode active material layer 20 has the inclined portion 20a that is inclined so that a width thereof reduces in a direction away from the positive electrode current collector 10, concentration of current at the boundary between the positive electrode active material layer 20 and the insulating member 50 can be suppressed. As a result, localized deposition of lithium on the negative electrode side containing metallic lithium or a lithium alloy can be suppressed.

Here, results of simulating a current density of the electrode laminate 1 is shown in FIG. 2. In FIG. 2, the uppermost line in the vertical direction on the paper represents a total current density (magnitude), the lowermost line in the vertical direction on the paper represents a current density in a y-direction, and the center line represents a current density in an x-direction.

As shown in FIG. 2, concentration of current is suppressed in the electrode laminate 1. Therefore, in the electrode laminate 1, localized deposition of lithium on the negative electrode side containing metallic lithium or a lithium alloy can be suppressed.

Although the embodiment of the present invention has been described in detail above, the present invention is not limited to the above-described embodiment, and various modifications and changes can be made within the range of the gist of the present invention described in the claims.

### EXAMPLES

Hereinafter, the present invention will be described more specifically with reference to experimental examples, but the present invention is not limited to the following experimental examples.

### Experimental Example 1

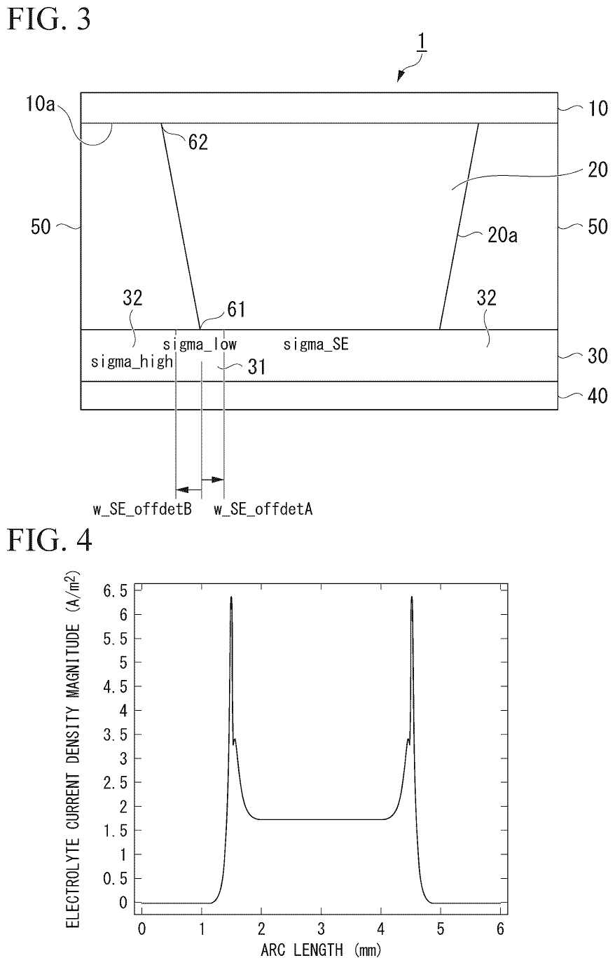

FIG. 4 shows results of simulating a current density of the solid electrolyte layer 30 of the electrode laminate 1 illustrated in FIG. 3. FIG. 4 is a diagram showing a relationship between a length of the solid electrolyte layer 30 in a width direction and a current density of the solid electrolyte layer 30.

From the results shown in FIG. 4, the current density of the solid electrolyte layer 30 was 0.57 S/m in the high ion conductivity region 32 (Sigma_high), 0.57 S/m in the low ion conductivity region 31 (Sigma_low), and 0.57 S/m in the central portion (Sigma_SE). Further, the w_SE_offset A shown in FIG. 4 (one direction in a direction perpendicular to a thickness direction of the solid electrolyte layer 30 (a direction to the left of the boundary line between the positive electrode active material layer 20 and the insulating member 50 in FIG. 3)) was 50 μm, and the w_SE_offset B (one direction in a direction perpendicular to the thickness direction of the solid electrolyte layer 30 (a direction to the right of the boundary between the positive electrode active material layer 20 and the insulating member 50 in FIG. 3)) was 50 μm.

Further,

### Experimental Example 2

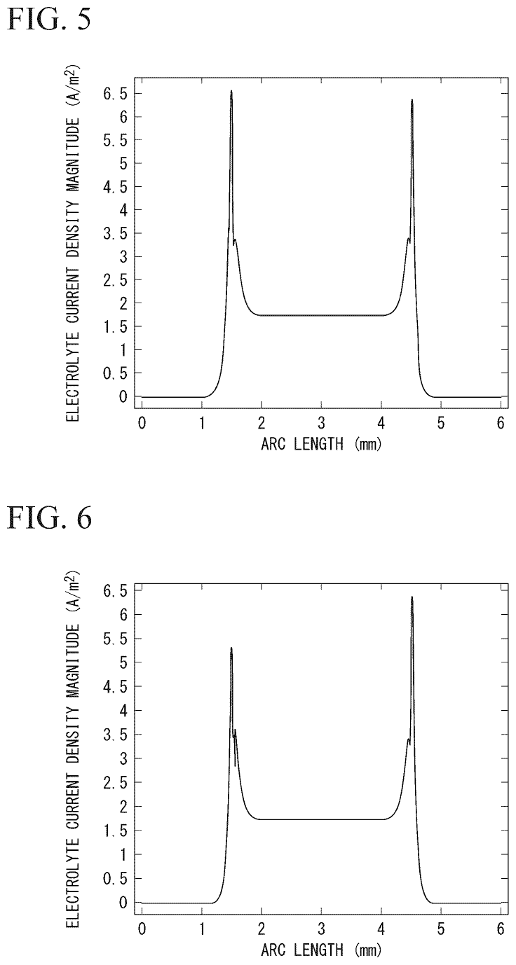

FIG. 5 shows results of simulating a current density of the solid electrolyte layer 30 of the electrode laminate 1 illustrated in FIG. 3. FIG. 5 is a diagram showing a relationship between a length of the solid electrolyte layer 30 in a width direction and a current density of the solid electrolyte layer 30.

From the results shown in FIG. 5, the current density of the solid electrolyte layer 30 was 1.00 S/m in the high ion conductivity region 32 (Sigma_high), 0.57 S/m in the low ion conductivity region 31 (Sigma_low), and 0.57 S/m in the central portion (Sigma_SE). Further, w_SE_offset A shown in FIG. 5 was 50 μm, and w_SE_offset B was 50 μm.

### Experimental Example 3

FIG. 6 shows results of simulating a current density of the solid electrolyte layer 30 of the electrode laminate 1 illustrated in FIG. 3. FIG. 6 is a diagram showing a relationship between a length of the solid electrolyte layer 30 in a width direction and a current density of the solid electrolyte layer 30.

From the results shown in FIG. 6, the current density of the solid electrolyte layer 30 was 0.57 S/m in the high ion conductivity region 32 (Sigma_high), 0.35 S/m in the low ion conductivity region 31 (Sigma_low), and 0.57 S/m in the central portion (Sigma_SE). Further, w_SE_offset A shown in FIG. 6 was 50 μm, and w_SE_offset B was 50 μm.

### Experimental Example 4

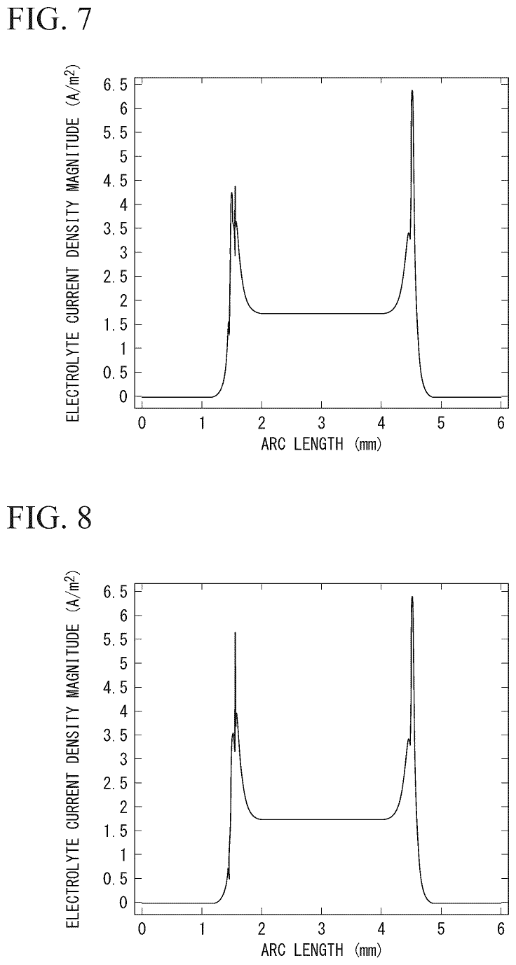

FIG. 7 shows results of simulating a current density of the solid electrolyte layer 30 of the electrode laminate 1 illustrated in FIG. 3. FIG. 7 is a diagram showing a relationship between a length of the solid electrolyte layer 30 in a width direction and a current density of the solid electrolyte layer 30.

From the results shown in FIG. 7, the current density of the solid electrolyte layer 30 was 0.57 S/m in the high ion conductivity region 32 (Sigma_high), 0.20 S/m in the low on conductivity region 31 (Sigma_low), and 0.57 S/m in the central portion (Sigma_SE). Further, w_SE_offset A shown in FIG. 7 was 50 μm, and w_SE_offset B was 50 μm.

### Experimental Example 5

FIG. 8 shows results of simulating a current density of the solid electrolyte layer 30 of the electrode laminate 1 illustrated in FIG. 3. FIG. 8 is a diagram showing a relationship between a length of the solid electrolyte layer 30 in a width direction and a current density of the solid electrolyte layer 30.

From the results shown in FIG. 8, the current density of the solid electrolyte layer 30 was 0.57 S/m in the high ion conductivity region 32 (Sigma_high), 0.10 S/m in the low ion conductivity region 31 (Sigma_low), and 0.57 S/m in the central portion (Sigma_SE). Further, w_SE_offset A shown in FIG. 8 was 50 μm, and w_SE_offset B was 50 μm.

### Experimental Example 6

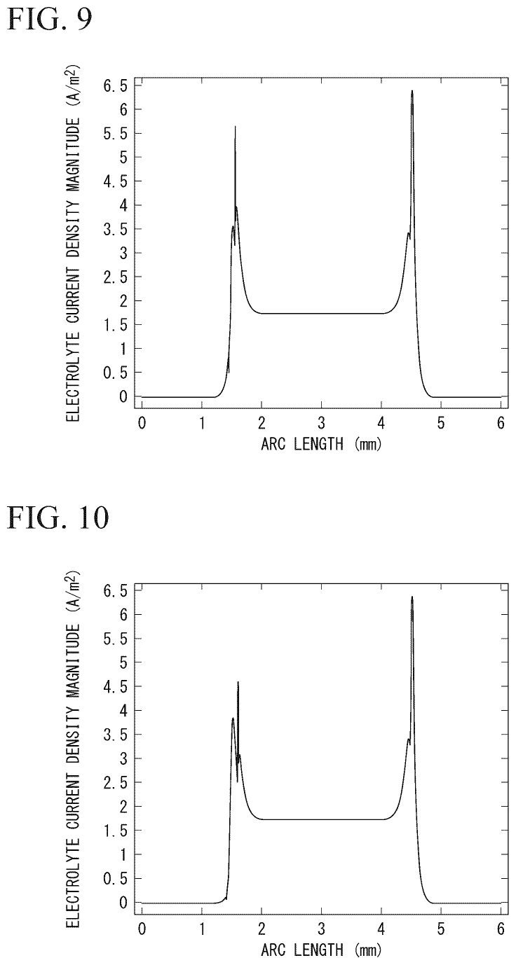

FIG. 9 shows results of simulating a current density of the solid electrolyte layer 30 of the electrode laminate 1 illustrated in FIG. 3. FIG. 9 is a diagram showing a relationship between a length of the solid electrolyte layer 30 in a width direction and a current density of the solid electrolyte layer 30.

From the results shown in FIG. 9, the current density of the solid electrolyte layer 30 was 0.57 S/m in the high ion conductivity region 32 (Sigma_high), 0.10 S/m in the low ion conductivity region 31 (Sigma_low), and 0.57 S/m in the central portion (Sigma_SE). Further, w_SE_offset A shown in FIG. 9 was 50 μm, and w_SE_offset B was 50 μm.

### Experimental Example 7

FIG. 10 shows results of simulating a current density of the solid electrolyte layer 30 of the electrode laminate 1 illustrated in FIG. 3. FIG. 10 is a diagram showing a relationship between a length of the solid electrolyte layer 30 in a width direction and a current density of the solid electrolyte layer 30.

From the results shown in FIG. 10, the current density of the solid electrolyte layer 30 was 0.57 S/m in the high ion conductivity region 32 (Sigma_high), 0.10 S/m in the low ion conductivity region 31 (Sigma_low), and 0.57 S/m in the central portion (Sigma_SE). Further, w_SE_offset A shown in FIG. 10 was 100 μm, and w_SE_offset B was 100 μm.

### Experimental Example 8

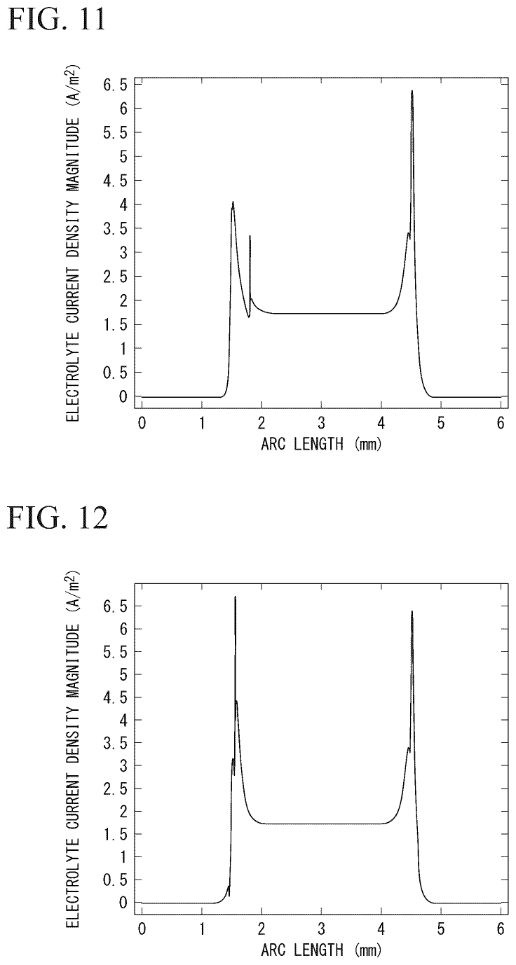

FIG. 11 shows results of simulating a current density of the solid electrolyte layer 30 of the electrode laminate 1 illustrated in FIG. 3. FIG. 11 is a diagram showing a relationship between a length of the solid electrolyte layer 30 in a width direction and a current density of the solid electrolyte layer 30.

From the results shown in FIG. 11, the current density of the solid electrolyte layer 30 was 0.57 S/m in the high ion conductivity region 32 (Sigma_high), 0.10 S/m in the low ion conductivity region 31 (Sigma_low), and 0.57 S/m in the central portion (Sigma_SE). Further, w_SE_offset A shown in FIG. 11 was 300 μm, and w_SE_offset B was 300 μm.

### Experimental Example 9

FIG. 12 shows results of simulating a current density of the solid electrolyte layer 30 of the electrode laminate 1 illustrated in FIG. 3. FIG. 12 is a diagram showing a relationship between a length of the solid electrolyte layer 30 in a width direction and a current density of the solid electrolyte layer 30.

From the results shown in FIG. 12, the current density of the solid electrolyte layer 30 was 0.57 S/m in the high ion conductivity region 32 (Sigma_high), 0.05 S/m in the low on conductivity region 31 (Sigma_low), and 0.57 S/m in the central portion (Sigma_SE). Further, w_SE_offset A shown in FIG. 12 was 50 μm, and w_SE_offset B was 50 μm.

### Experimental Example 10

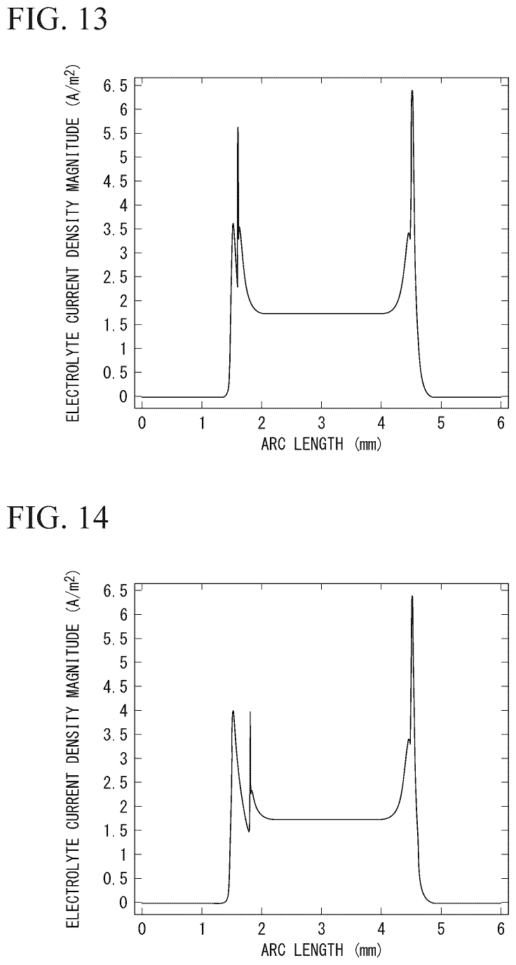

FIG. 13 shows results of simulating a current density of the solid electrolyte layer 30 of the electrode laminate 1 illustrated in FIG. 3. FIG. 13 is a diagram showing a relationship between a length of the solid electrolyte layer 30 in a width direction and a current density of the solid electrolyte layer 30.

From the results shown in FIG. 13, the current density of the solid electrolyte layer 30 was 0.57 S/m in the high ion conductivity region 32 (Sigma_high), 0.05 S/m in the low ion conductivity region 31 (Sigma_low), and 0.57 S/m in the central portion (Sigma_SE). Further, w_SE_offset A shown in FIG. 13 was 100 μm, and w_SE_offset B was 100 μm.

### Experimental Example 11

FIG. 14 shows results of simulating a current density of the solid electrolyte layer 30 of the electrode laminate 1 illustrated in FIG. 3. FIG. 14 is a diagram showing a relationship between a length of the solid electrolyte layer 30 in a width direction and a current density of the solid electrolyte layer 30.

From the results shown in FIG. 14, the current density of the solid electrolyte layer 30 was 0.57 S/m in the high ion conductivity region 32 (Sigma_high), 0.05 S/m in the low ion conductivity region 31 (Sigma_low), and 0.57 S/m in the central portion (Sigma_SE). Further, w_SE_offset A shown in FIG. 14 was 300 μm, and w_SE_offset B was 300 μm.

### Experimental Example 12

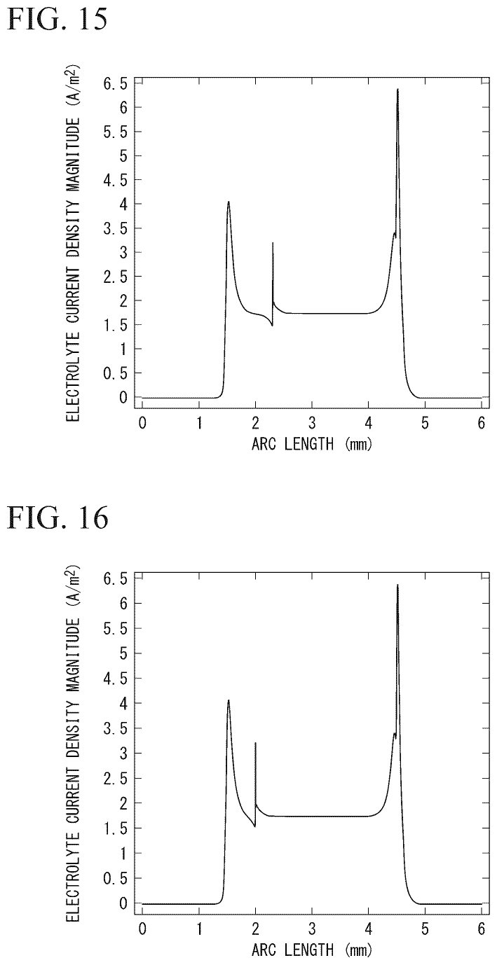

FIG. 15 shows results of simulating a current density of the solid electrolyte layer 30 of the electrode laminate 1 illustrated in FIG. 3. FIG. 15 is a diagram showing a relationship between a length of the solid electrolyte layer 30 in a width direction and a current density of the solid electrolyte layer 30.

From the results shown in FIG. 15, the current density of the solid electrolyte layer 30 was 0.57 S/m in the high ion conductivity region 32 (Sigma_high), 0.10 S/m in the low ion conductivity region 31 (Sigma_low), and 0.57 S/m in the central portion (Sigma_SE). Further, w_SE_offset A shown in FIG. 15 was 800 μm, and w_SE_offset B was 300 μm.

### Experimental Example 13

FIG. 16 shows results of simulating a current density of the solid electrolyte layer 30 of the electrode laminate 1 illustrated in FIG. 3. FIG. 16 is a diagram showing a relationship between a length of the solid electrolyte layer 30 in a width direction and a current density of the solid electrolyte layer 30.

From the results shown in FIG. 16, the current density of the solid electrolyte layer 30 was 0.57 S/m in the high ion conductivity region 32 (Sigma_high), 0.10 S/m in the low ion conductivity region 31 (Sigma_low), and 0.57 S/m in the central portion (Sigma_SE). Further, w_SE_offset A shown in FIG. 16 was 500 μm, and w_SE_offset B was 300 μm.

### Experimental Example 14

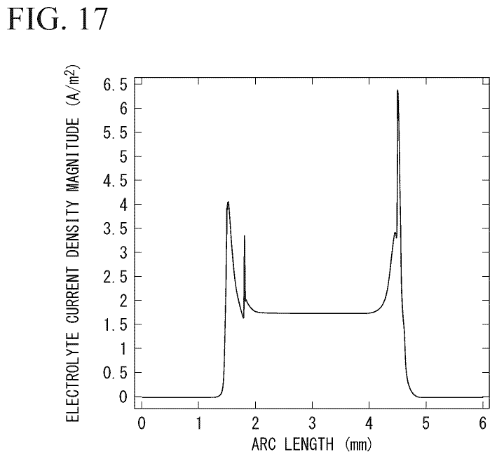

FIG. 17 shows results of simulating a current density of the solid electrolyte layer 30 of the electrode laminate 1 illustrated in FIG. 3. FIG. 17 is a diagram showing a relationship between a length of the solid electrolyte layer 30 in a width direction and a current density of the solid electrolyte layer 30.

From the results shown in FIG. 17, the current density of the solid electrolyte layer 30 was 0.57 S/m in the high ion conductivity region 32 (Sigma_high), 0.10 S/m in the low on conductivity region 31 (Sigma_low), and 0.57 S/m in the central portion (Sigma_SE). Further, w_SE_offset A shown in FIG. 17 was 300 μm, and w_SE_offset B was 300 μm.

As shown in experimental examples 1 to 11, concentration of current is suppressed in the electrode laminate 1. Therefore, in the electrode laminate 1, localized deposition of lithium on the negative electrode side containing metallic lithium or a lithium alloy can be suppressed.

As shown in experimental examples 12 to 14, even if w_SE_offset A was set to 300 μm, 500 μm, or 800 μm, there was no significant difference in the effect of suppressing concentration of current in the electrode laminate 1.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Electrode laminate
10 Positive electrode current collector
20 Positive electrode active material layer
30 Solid electrolyte layer
31 Low ion conductivity region
32 High ion conductivity region
40 Negative electrode current collector
50 Insulating member
61 First contact portion
62 Second contact portion

What is claimed is:

1. An electrode laminate, which is an electrode laminate utilizing a deposition-dissolution reaction of metallic lithium as a reaction of a negative electrode, comprising a positive electrode current collector, a positive electrode active material layer, a solid electrolyte layer, and a negative electrode current collector, wherein
an insulating member is disposed on an outer circumference of the positive electrode active material layer,
the solid electrolyte layer has a low ion conductivity region, in which an ionic conductivity of a solid electrolyte is lower than an ionic conductivity of a solid electrolyte at a central portion of the solid electrolyte layer, in a region extending from a boundary line between the positive electrode active material layer and the insulating member to a distance A in one direction in a direction perpendicular to a thickness direction of the solid electrolyte layer and a region extending from the boundary line between the positive electrode active material layer and the insulating member to a distance B in the other direction in a direction perpendicular to the thickness direction of the solid electrolyte layer,
the positive electrode active material layer has an inclined portion which is inclined so that a width thereof reduces in a direction away from the positive electrode current collector.

2. The electrode laminate according to claim 1, wherein the distance A and the distance B satisfy the following relational expression (1):
Distance A≥Distance B (1)

3. The electrode laminate according to claim 1, wherein a first contact portion, at which the inclined portion and the solid electrolyte layer are in contact, has a high proportion of the low ion conductivity region in a distance from a second contact portion, at which the inclined portion and the positive electrode current collector are in contact, to a point on the solid electrolyte layer when a straight line is drawn in a lamination direction.

4. The electrode laminate according to claim 1, wherein the distance A is 500 μm or less, and the distance B is 500 μm or less.
